(19) United States
(12) Patent Application Publication
(10) Pub. No.: US 2025/0178323 A1
(43) Pub. Date: Jun. 5, 2025

(54) METHOD FOR PRODUCING LAMINATE

(71) Applicant: KANEKA CORPORATION, Osaka-shi (JP)

(72) Inventors: Yasunori OKADA, Settsu-shi (JP); Itsuki KUSAKABE, Settsu-shi (JP); Tomofumi KUBOTA, Settsu-shi (JP)

(73) Assignee: KANEKA CORPORATION, Osaka-shi (JP)

(21) Appl. No.: 19/046,604

(22) Filed: Feb. 6, 2025

Related U.S. Application Data
(63) Continuation of application No. PCT/JP2023/028869, filed on Aug. 8, 2023.

(30) Foreign Application Priority Data
Aug. 17, 2022 (JP) 2022-129958

(51) Int. Cl. B32B 27/10; B32B 1/00; B32B 7/12; B32B 27/36; B65D 65/40

(52) U.S. Cl. CPC B32B 27/10; B32B 1/00; B32B 7/12; B32B 27/36; B65D 65/40; B32B 2250/02; B32B 2439/70

(57) ABSTRACT

Provided is a method for producing a laminate including a paper substrate layer and a resin layer formed on at least one side of the paper substrate layer, the resin layer containing a polyhydroxyalkanoate resin. The method includes the steps of: molding a polyhydroxyalkanoate resin into a film, wherein in differential scanning calorimetry of the polyhydroxyalkanoate resin, a highest melting peak temperature is 130° C. or higher and a total crystalline melting enthalpy calculated from all melting peaks is in a range of 30 to 65 J/g (step i); applying an adhesive to one side of the film to form an adhesive layer (step ii); and placing the paper substrate layer on a surface of the adhesive layer (step iii).

### TECHNICAL FIELD

The present invention relates to a method for producing a laminate including a paper substrate layer and a resin layer containing a polyhydroxyalkanoate resin.

### BACKGROUND ART

Laminates made with paper substrates are used as packaging materials such as paper cups, paper trays, paper cartons, and paper bags in diverse fields including food applications. Among such laminates there is a laminate in which a layer of a synthetic resin such as polyethylene, polypropylene, or polyester is located on a paper substrate to improve tearing resistance, water resistance, oil resistance, and processability in heat sealing or any other process.

In recent years, environmental problems due to waste plastics have become an issue of great concern. In particular, waste plastics have caused serious marine pollution. Biodegradable plastics, which are degradable in the natural environment, are expected to be widely used as an alternative to synthetic resins.

Various kinds of such biodegradable plastics are known. In particular, polyhydroxyalkanoate resins (hereinafter also referred to as “PHA resins”) are thermoplastic polyesters produced and accumulated as energy storage substances in the cells of many kinds of microorganisms, and these resins are biodegradable in seawater as well as in soil and thus are attracting attention as materials that can be a solution to the above-mentioned problems.

Laminated paper produced by laminating a paper substrate with such a PHA resin is very promising in terms of environmental protection because both the paper and the PHA resin are environmentally degradable materials.

Laminated paper made with a PHA resin can be produced by a method in which a layer of the PHA resin is formed on a paper substrate by extrusion lamination. The resulting laminate can have sufficient lamination strength by virtue of an anchor effect arising from physical infiltration of the molten resin into the paper. However, when paper having a high air resistance is used to enhance the water repellency and oil repellency of the resulting packaging material, the molten resin fails to sufficiently infiltrate the paper, and this makes it difficult to achieve good lamination strength. In particular, in the case of using a P3HA resin, it is difficult to achieve improved lamination strength by increasing the processing temperature because there is only a small difference between the temperature range where the P3HA resin exhibits a melt viscosity suitable for sufficient infiltration into the paper and the temperature range where the P3HA resin is thermally decomposed.

Patent Literature 1 discloses that good lamination strength can be achieved by first applying a dispersion or an emulsion of polycaprolactone to paper, drying the dispersion or emulsion, and then forming a layer of a PHA resin on the polycaprolactone layer by extrusion lamination.

However, this method requires that, in order to form a polycaprolactone layer having a thickness required to ensure the lamination strength, the dispersion or emulsion containing an organic solvent should be applied in a relatively large amount per unit area taking into account seeping of the organic solvent into the paper. The organic solvent is thus likely to remain in the paper, and there is room for improvement from a hygiene perspective when it comes to using the laminate as a packaging material for food applications.

### CITATION LIST

### Patent Literature

PTL 1: Japanese Laid-Open Patent Application Publication No. H6-293113

### SUMMARY OF INVENTION

### Technical Problem

A dry lamination method is also known in which: a PHA resin is molded into a film first; then an adhesive is applied to the film of the PHA resin and dried by heating; and subsequently the film of the PHA resin is attached to a paper substrate via the adhesive. This method can achieve sufficient lamination strength and significantly reduce the risk that the solvent remains in the paper.

However, the following problem has been found to occur in the case of using, for example, poly (3-hydroxybutyrate-co-3-hydroxyhexanoate) as the PHA resin and increasing the proportion of 3-hydroxyhexanoate to obtain a laminate having high toughness required of a packaging material: the PHA resin suffers from reduced crystallinity which causes the film to undergo deformation such as extension, contraction, or corrugation in the step of applying the adhesive and drying the applied adhesive by heating, and the deformation results in the film having a portion (unbonded portion) that is not bonded to the paper substrate when the film is attached to the paper substrate.

In view of the above circumstances, the present invention aims to provide a method for producing a laminate including a paper substrate layer and a resin layer formed on at least one side of the paper substrate layer and containing a polyhydroxyalkanoate resin, the method being adapted to allow the produced laminate to have high adhesion between the paper substrate layer and the PHA resin layer, in particular even when the paper substrate used has a high air resistance, have a good appearance with the PHA resin layer having no portion unbonded to the paper substrate layer, exhibit good biodegradation properties such as marine degradability, and have high toughness suitable for use as a molded article such as a packaging material.

### Solution to Problem

As a result of intensive studies with the goal of solving the above problem, the present inventors have found that the problem can be solved by using a film of a PHA resin composed such that in differential scanning calorimetry of the PHA resin, a highest melting peak is 130° C. or higher and a total crystalline melting enthalpy calculated from all melting peaks is in a given range. Based on this finding, the inventors have completed the present invention.

Specifically, the present invention relates to a method for producing a laminate including a paper substrate layer and a resin layer formed on at least one side of the paper substrate layer, the paper substrate layer having an air resistance of 90 sec or more, the resin layer containing a polyhydroxyalkanoate resin, the method including the sequential steps of:
(i) molding a film containing a polyhydroxyalkanoate resin component, wherein in differential scanning calorimetry of the polyhydroxyalkanoate resin component, a highest melting peak temperature is 130° C. or higher and a total crystalline melting enthalpy calculated from all melting peaks is in a range of 30 to 65 J/g;
(ii) applying an adhesive to one side of the film to form an adhesive layer; and
(iii) placing the paper substrate layer on a surface of the adhesive layer.

### Advantageous Effects of Invention

The present invention can provide: a laminate that includes a paper substrate layer having a high air resistance and a resin layer containing a polyhydroxyalkanoate resin, the laminate having both high interlayer adhesion and a good appearance, being able to exhibit good biodegradation properties such as marine degradability, and having high toughness; and a molded article including the laminate. Furthermore, despite the use of an adhesive, the present invention allows for production of a laminate having little solvent odor derived from the adhesive and production of a molded article including the laminate.

### BRIEF DESCRIPTION OF DRAWINGS

FIG. 1 is a schematic diagram showing a DSC curve obtained for PHA resin pellets 1 of an example of the present invention.

### DESCRIPTION OF EMBODIMENTS

Hereinafter, an embodiment of the present invention will be described. The present invention is not limited to the embodiment described below.

### Laminate

A laminate according to the present embodiment includes at least a paper substrate layer and a resin layer located on at least one side of the paper substrate layer, with an adhesive layer interposed between the paper substrate layer and the resin layer. The resin layer contains a polyhydroxyalkanoate resin (hereinafter also referred to as a “PHA resin”). Being located as at least one of the outermost layers of the laminate, the resin layer can be used as a waterproof layer, an oil-resistant layer, or a heat-scalable layer. The following will describe each of the layers of the laminate.

### Paper Substrate Layer

The paper substrate layer is not limited to a particular type of paper and may be any commonly used paper made primarily of plant-derived pulp. The paper used as the paper substrate layer can be selected as appropriate depending on the intended use of the laminate. Specific examples of the paper include cup paper, unbleached kraft paper, treated kraft paper such as bleached kraft paper or single-sided glossy kraft paper, high-quality paper, coated paper, tissue paper, glassine paper, and paperboard. The paper may contain an additive added as necessary, such as a waterproofing agent, a water repellent, or an inorganic substance. The surface of the paper may be treated with any of various chemicals such as starches, polyacrylamide, polyvinyl alcohol, a surface sizing agent, a lubricant, and a stain-proofing agent.

The weight per square meter of the paper substrate layer is not limited to a particular range but is preferably from 20 to 400 g/m², more preferably from 30 to 320 g/m², and even more preferably from 60 to 300 g/m². When the weight per square meter is in such a range, the use of the paper substrate layer in producing a packaging material makes it easier to achieve practically sufficient mechanical strength of the packaging material.

In the present embodiment, the air resistance (in particular, air resistance as determined according to JIS P 8117) of the paper substrate layer is 90 sec or more and preferably 100 sec or more. The fact that the air resistance is 90 sec or more means that the paper substrate layer has high barrier performance in terms of shielding against air and can contribute to enhancement of water repellency and oil repellency. The upper limit of the air resistance is not limited to a particular value. Preferably, the air resistance is 300 sec or less. There is no particular limitation on how to achieve an air resistance of 90 sec or more. For example, such an air resistance can be achieved by setting the density of the paper substrate layer to 0.80 g/cm³ or more and the surface smoothness (JIS P 8155) of the paper substrate layer to 15 or more.

The side of the paper substrate layer that is to be brought into contact with the adhesive layer may be subjected to a surface treatment such as corona treatment, plasm treatment, flame treatment, ozone treatment, or anchor coat treatment. One of these surface treatments may be performed alone, or two or more surface treatments may be used in combination.

### Resin Layer

The resin layer is a resin layer containing at least one PHA resin component. In differential scanning calorimetry of the PHA resin component, a highest melting peak temperature is 130° C. or higher and a total crystalline melting enthalpy calculated from all melting peaks is in the range of 30 to 65 J/g. The resin layer may further contain a resin component other than the PHA resin component.

### PHA Resin Component

The PHA resin component of the present embodiment may be a single PHA resin or a combination of two or more PHA resins. Examples of the PHA resin component include polymers having 3-hydroxyalkanoate structural units (monomer units) and/or 4-hydroxyalkanoate structural units and having degradability in seawater. In particular, a polymer containing 3-hydroxyalkanoate structural units represented by the following formula (1) is preferred.

[—CHR—CH₂—CO—O—] (1)

In the formula (1), R is an alkyl group represented by CₚH₂ₚ₊₁, and p is an integer from 1 to 15. Examples of the R group include linear or branched alkyl groups such as methyl, ethyl, propyl, methylpropyl, butyl, isobutyl, t-butyl, pentyl, and hexyl groups. The integer p is preferably from 1 to 10 and more preferably from 1 to 8.

It is particularly preferable for the PHA resin component to include a poly (3-hydroxyalkanoate) resin (hereinafter also referred to as a “P3HA resin”) produced from a microorganism. In the microbially produced P3HA resin, all of the 3-hydroxyalkanoate structural units are contained as (R)-3-hydroxyalkanoate structural units.

The P3HA resin component preferably contains 50 mol % or more, more preferably 60 mol % or more, even more preferably 70 mol % or more, of 3-hydroxyalkanoate structural units (in particular, the structural units represented by the formula (1)) in the total structural units. The P3HA resin may contain only one type or two or more types of 3-hydroxyalkanoate structural units as structural units or may contain other structural units (such as 4-hydroxyalkanoate structural units) in addition to the one type or two or more types of 3-hydroxyalkanoate structural units.

It is preferable for the P3HA resin component to include a P3HB resin containing 3-hydroxybutyrate (hereinafter also referred to as “3HB”) structural units. In particular, all of the 3-hydroxybutyrate structural units are preferably (R)-3-hydroxybutyrate structural units.

Specific examples of the P3HB resin include poly (3-hydroxybutyrate), poly (3-hydroxybutyrate-co-3-hydroxypropionate), poly (3-hydroxybutyrate-co-3-hydroxyvalerate) abbreviated as “P3HB3HV”, poly (3-hydroxybutyrate-co-3-hydroxyvalerate-3-hydroxyhexanoate), poly (3-hydroxybutyrate-co-3-hydroxyhexanoate) abbreviated as “P3HB3HH”, poly (3-hydroxybutyrate-co-3-hydroxyheptanoate), poly (3-hydroxybutyrate-co-3-hydroxyoctanoate), poly (3-hydroxybutyrate-co-3-hydroxynonanoate), poly (3-hydroxybutyrate-co-3-hydroxydecanoate), poly (3-hydroxybutyrate-co-3-hydroxyumdecanoate), and poly (3-hydroxybutyrate-co-4-hydroxybutyrate) abbreviated as “P3HB4HB”. The way of copolymerization is not limited to a particular type and may be random copolymerization, alternating copolymerization, block copolymerization, or graft copolymerization. Random copolymerization is preferred. In terms of factors such as processability and mechanical properties, P3HB3HH and P3HB4HB are preferred, and P3HB3HH is particularly preferred. P3HB3HH has the following advantages: its melting point and crystallinity can be changed by varying the proportions of the constituent monomers, and thus its physical properties such as Young's modulus and heat resistance can be adjusted and controlled to levels intermediate between those of polypropylene and polyethylene; and P3HB3HH is easy to industrially produce. Furthermore, P3HB3HH can have a low melting point and be heat-sealed at a relatively low temperature. Thus, the use of P3HB3HH makes it possible to prevent the paper substrate layer from discoloring due to heat during heat scaling.

When the PHA resin component of the present embodiment includes a PHA resin containing 3-hydroxybutyrate structural units, the average content ratio between 3-hydroxybutyrate and another monomer (3-hydroxybutyrate/another monomer) in the total PHA resin component is preferably from 94/6 to 83/17 (mol %/mol %), more preferably from 92/8 to 84/16 (mol %/mol %), and even more preferably from 90/10 to 85/15. When the 3-hydroxybutyrate content is 94 mol % or less, sufficient mechanical properties are likely to be achieved. When the 3-hydroxybutyrate content is 85% or more, the resin exhibits a high crystallization speed by virtue of which a practically sufficient solidification speed is likely to be achieved when the resin layer is molded as a film or heat-scaled.

The average content ratio between different monomers in the total P3HB resin component can be determined by a method known to those skilled in the art such as a method described in paragraph of WO 2013/147139. The average content ratio refers to a molar ratio between 3-hydroxybutyrate and another monomer contained in the total P3HB resin component. When the PHA resin component is a mixture of two or more PHA resins, the average content ratio refers to a molar ratio between different monomers contained in the total mixture.

The weight-average molecular weight of the PHA resin component is not limited to a particular range but is preferably from 10×10⁴ to 150×10⁴, more preferably from 15×10⁴ to 100×10⁴, and even more preferably from 20×10⁴ to 70×10⁴. When the weight-average molecular weight is 10×10+or more, the resulting PHA resin component tends to have improved mechanical properties. When the weight-average molecular weight is 150×10⁴ or less, the load imposed on a machine during melt processing tends to be low, and the productivity tends to be high.

When the PHA resin component is a mixture of two or more PHA resins, the weight-average molecular weight of each PHA resin is not limited to a particular range. However, when, for example, high-crystallinity and low-crystallinity PHA resins as described later are blended, the weight-average molecular weight of the high-crystallinity polyhydroxyalkanoate resin is preferably from 20×10⁴ to 100×10⁴, more preferably from 25×10⁴ to 70×10⁴, and even more preferably from 30×10⁴ to 65×10⁴. When the weight-average molecular weight of the high-crystallinity PHA resin is 20×10⁴ or more, the resulting PHA resin component tends to have improved mechanical properties. When the weight-average molecular weight is 100×10⁴ or less, the heat sealability tends to be improved thanks to a low viscosity during melting. The weight-average molecular weight of the low-crystallinity PHA resin is preferably from 10×10⁴ to 150×10⁴, more preferably from 15×10⁴ to 100×10⁴, and even more preferably from 20×10⁴ to 70×10⁴. When the weight-average molecular weight of the low-crystallinity PHA resin is 10×10⁴ or more, the resulting PHA resin component tends to have improved mechanical properties. When the weight-average molecular weight is 150×10⁴ or less, the processability tends to be improved thanks to a sufficient crystallization speed.

The weight-average molecular weight of the PHA resin component or a PHA resin included in the PHA resin component can be measured as a polystyrene-equivalent molecular weight by gel permeation chromatography (HPLC GPC system manufactured by Shimadzu Corporation) using a chloroform solution of the PHA resin component or the PHA resin. The column used in the gel permeation chromatography may be any column suitable for weight-average molecular weight measurement and may be, for example, a polystyrene gel column (“Shodex K-804” manufactured by Showa Denko K.K.).

The PHA resin production is not limited to using a particular method and may be accomplished by a production method using chemical synthesis or a microbial production method. A microbial production method is preferred. The microbial production method used can be any known method. Known examples of bacteria that produce copolymers of 3-hydroxybutyrate with other hydroxyalkanoates include Aeromonas caviae which is a P3HB3HV-and P3HB3HH-producing bacterium and Alcaligenes eutrophus which is a P3HB4HB-producing bacterium. In particular, Alcaligenes eutrophus AC32 (FERM BP-6038; see T. Fukui, Y. Doi, J. Bacteriol., 179, pp. 4821-4830 (1997)) incorporating a P3HA synthase gene is known to be effective to increase the P3HB3HH productivity. Such a microorganism is cultured under suitable conditions to allow the microorganism to accumulate P3HB3HH in its cells, and the microbial cells accumulating P3HB3HH are used. Instead of the microorganisms mentioned above, a genetically modified microorganism incorporating any suitable PHA resin synthesis-related gene may be used depending on the PHA resin to be produced. The culture conditions including the type of the culture substrate may be optimized depending on the PHA resin to be produced. For example, a PHA resin can be produced by a method described in WO 2010/013483. Examples of commercially-available P3HB3HH include “Kaneka Biodegradable Polymer Green Planet™” of Kaneka Corporation.

### Melting Behavior of PHA Resin Component

In differential scanning calorimetry of the PHA resin component of the present embodiment, a highest melting peak temperature is 130° C. or higher. The highest melting peak temperature is preferably from 130 to 165° C., more preferably from 135 to 160° C., and even more preferably from 140 to 155° C. The use of the PHA resin component having such a melting peak temperature can prevent the resin layer molded as a film from being extended, contracted, or corrugated in the step of applying an adhesive to the resin layer and drying the applied adhesive by heating. Additionally, it becomes easier to increase the drying temperature in order to reduce the risk that the solvent contained in the adhesive remains in the laminate or enhance the productivity of dry lamination. Furthermore, when the resin layer is used as a heat-scalable layer, crystals of this melting-point component do not completely melt but remain and act as crystal nuclei to accelerate the solidification of the resin layer during heat sealing. If there is a melting peak temperature in a temperature region above 165° C., the amount of remaining crystal nuclei of the high-melting-point resin component is extremely large, and molding of the resin layer as a film or sheet fails to result in the film or sheet being smooth and having a uniform thickness. The extremely large amount of remaining crystal nuclei also causes a decline in heat scalability. Increasing the heat sealing temperature to moderate the amount of remaining crystal nuclei could cause significant thermal decomposition of the resin.

The highest melting peak temperature exhibited by the PHA resin component is measured as the highest of temperatures at which melting peaks appear in a DSC curve obtained by differential scanning calorimetry which uses a differential scanning calorimeter (DSC 25 manufactured by TA Instruments) and in which about 4 to 10 mg of the PHA resin component is heated from 20 to 180° C. at a temperature increase rate of 10° C./min.

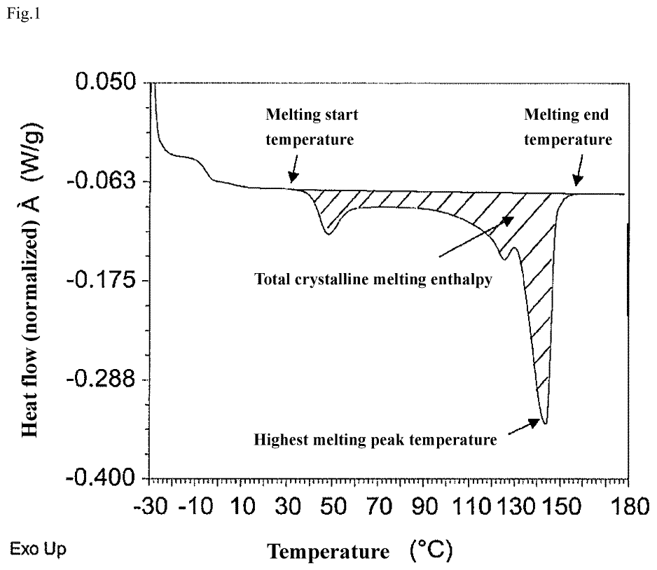

As shown in the DSC curve of FIG. 1, the PHA resin component of the present embodiment may have, in addition to the highest-temperature melting peak, another melting peak in a temperature region below the temperature at which the highest-temperature melting peak is located. For example, the PHA resin component may have a melting peak at a temperature of 100° C. or lower.

In differential scanning calorimetry of the PHA resin component of the present embodiment, a total crystalline melting enthalpy calculated from all melting peaks is in the range of 30 to 65 J/g. By virtue of the fact that the total crystalline melting enthalpy is in this range, the use of the PHA resin component can enhance the toughness of the resin layer and at the same time prevent the resin layer molded as a film from being extended, contracted, or corrugated in the step of applying an adhesive to the resin layer and drying the applied adhesive by heating. The total crystalline melting enthalpy is preferably from 40 to 65 J/g and more preferably from 50 to 64 J/g.

The total crystalline melting enthalpy calculated from all melting peaks refers to the sum of the crystalline melting enthalpies of the melting peaks. Specifically, in a DSC curve obtained as described above, baselines observed before the start of melting and after the end of melting are connected by a straight line, and the total crystalline melting enthalpy is calculated as the area of the melting zone surrounded by the straight line and the DSC curve (hatched zone in FIG. 1).

### Method for Producing PHA Resin Component

Examples of methods for producing the polyhydroxyalkanoate resin component that exhibits the melting behavior described above include: a method which is used when the PHA resin in the component is a copolymer and in which the copolymerization ratio between the monomers constituting the copolymer is adjusted appropriately; a method in which a component other than PHA resins, such as a plasticizer, is added; and a method in which at least two PHA resins differing in melting behavior are mixed. In particular, the method is preferred in which at least two PHA resins differing in melting behavior are mixed. Specifically, it is preferable to mix at least two PHA resins each of which exhibits a different crystalline melting enthalpy. In this case, it is easy to ensure that in differential scanning calorimetry of the PHA resin component, the highest melting peak temperature is 130° C. or higher and the total crystalline melting enthalpy calculated from all melting peaks is in the range of 30 to 65 J/g.

When at least two PHA resins are mixed, the at least two PHA resins preferably include a combination of at least one high-crystallinity PHA resin and at least one low-crystallinity PHA resin. In general, high-crystallinity PHA resins are superior in processability but have low mechanical strength, while low-crystallinity PHA resins are inferior in processability but have good mechanical properties. The combined use of a high-crystallinity PHA resin and a low-crystallinity PHA resin allows the resulting PHA resin component to excel in both processability and mechanical properties.

When the high-crystallinity PHA resin contains 3-hydroxybutyrate structural units, the average 3-hydroxybutyrate structural unit content in the high-crystallinity PHA resin is preferably higher than the average 3-hydroxybutyrate structural unit content in the total PHA resin component. When the high-crystallinity PHA resin contains 3-hydroxybutyrate and another monomer, the average content ratio between 3-hydroxybutyrate and the other monomer (3-hydroxybutyrate/other monomer) in the high-crystallinity resin is preferably from 90/10 to 99/1 (mol %/mol %).

The high-crystallinity PHA resin component is preferably poly (3-hydroxybutyrate-co-3-hydroxyhexanoate) or poly (3-hydroxybutyrate-co-4-hydroxybutyrate). When the high-crystallinity PHA resin is poly (3-hydroxybutyrate-co-3-hydroxyhexanoate), the average 3-hydroxyhexanoate structural unit content in the resin is preferably from 1 to 6 mol %.

When the PHA resin component of the present embodiment contains 3-hydroxybutyrate structural units, the average 3-hydroxybutyrate structural unit content in the low-crystallinity PHA resin is preferably lower than the average 3-hydroxybutyrate structural unit content in the total PHA resin component. When the low-crystallinity PHA resin contains 3-hydroxybutyrate and another monomer, the average content ratio between 3-hydroxybutyrate and the other monomer (3-hydroxybutyrate/other monomer) in the low-crystallinity resin is preferably from 80/20 to 0/100 (mol %/mol %).

The low-crystallinity PHA resin is preferably poly (3-hydroxybutyrate-co-3-hydroxyhexanoate) or poly (3-hydroxybutyrate-co-4-hydroxybutyrate). When the low-crystallinity PHA resin is poly (3-hydroxybutyrate-co-3-hydroxyhexanoate), the average 3-hydroxyhexanoate structural unit content in the resin is preferably 24 mol % or more, more preferably from 24 to 99 mol %, even more preferably 24 to 50 mol %, and particularly preferably from 24 to 30 mol %.

When the high-crystallinity and low-crystallinity PHA resins described above are used in combination, the proportions of the two resins in their mixture are not limited to particular ranges. Preferably, the proportion of the high-crystallinity PHA resin is from 50 to 80 wt % and the proportion of the low-crystallinity PHA resin is from 20 to 50 wt %. More preferably, the proportion of the high-crystallinity PHA resin is from 65 to 75 wt % and the proportion of the low-crystallinity PHA resin is from 25 to 35 wt %.

Blending of two or more PHA resins is not limited to using a particular method. A blend of two or more PHA resins may be obtained by producing the resins together in a microorganism or may be obtained by chemical synthesis. A blend of two or more resins may be obtained by melting and kneading the resins using a device such as an extruder, a kneader, a Banbury mixer, or a roll mill or may be obtained by dissolving and mixing the resins in a solvent and drying the resulting mixture.

### Additional Resins

The resin layer may contain one additional resin or two or more additional resins in addition to the PHA resin component to the extent that the effect of the invention is achieved. Examples of such additional resins include: aliphatic polyester resins such as polybutylene succinate adipate, polybutylene succinate, polycaprolactone, and polylactic acid; and aliphatic-aromatic polyester resins such as polybutylene adipate terephthalate, polybutylene sebacate terephthalate, and polybutylene azelate terephthalate.

The amount of the additional resin(s) is not limited to a particular range and may vary to the extent that the effect of the invention is achieved. The amount of the additional resin(s) is preferably 30 parts by weight or less, more preferably 20 parts by weight or less, and even more preferably 10 parts by weight or less per 100 parts by weight of the PHA resin component. The lower limit of the amount of the additional resin(s) is not limited to a particular value, and the amount of the additional resin(s) may be 0 part by weight.

### Additives

The resin layer may contain additives commonly used in the art to the extent that the effect of the invention is achieved. Examples of such additives include: inorganic fillers such as talc, calcium carbonate, mica, silica, titanium oxide, and alumina; organic fillers such as chaff, wood powder, waste paper (e.g., newspaper), various kinds of starch, and cellulose; colorants such as pigments and dyes; odor absorbers such as activated carbon and zeolite; flavors such as vanillin and dextrin; and various other additives such as plasticizers, oxidation inhibitors, antioxidants, weathering resistance improvers, ultraviolet absorbers, hydrolysis inhibitors, nucleating agents, lubricants, mold releases, water repellents, antimicrobials, slidability improvers, tackifiers, fillers, and chemicals. The resin layer may contain only one additive or may contain two or more additives. The amount of the additive(s) can be set by those skilled in the art as appropriate depending on the intended purpose. Biodegradable additives are particularly preferred.

Examples of nucleating agents that can accelerate crystallization of the PHA resin component include pentaerythritol, orotic acid, aspartame, cyanuric acid, glycine, zinc phenylphosphonate, and boron nitride. Among these, pentaerythritol is preferred because it is particularly superior in the accelerating effect on crystallization of the polyhydroxyalkanoate resin component. The amount of the nucleating agent used is not limited to a particular range but is preferably from 0.1 to 5 parts by weight, more preferably from 0.5 to 3 parts by weight, and even more preferably from 0.7 to 1.5 parts by weight per 100 parts by weight of the PHA resin component. One nucleating agent may be used alone, or two or more nucleating agents may be mixed. The mix proportions of the nucleating agents can be adjusted as appropriate depending on the intended purpose.

Examples of lubricants include behenamide, oleamide, erucamide, stearamide, palmitamide, N-stearyl behenamide, N-stearyl erucamide, ethylene bis(stearamide), ethylene bis(oleamide), ethylene bis(erucamide), ethylene bis(lauramide), ethylene bis(capramide), p-phenylene bis(stearamide), and a polycondensation product of ethylenediamine, stearic acid, and sebacic acid. Among these, behenamide and erucamide are preferred because they are particularly superior in the lubricating effect on the PHA resin component. The amount of the lubricant used is not limited to a particular range but is preferably from 0.01 to 5 parts by weight, more preferably from 0.05 to 3 parts by weight, and even more preferably from 0.1 to 1.5 parts by weight per 100 parts by weight of the PHA resin component. One lubricant may be used alone, or two or more lubricants may be mixed. The mix proportions of the lubricants can be adjusted as appropriate depending on the intended purpose.

Examples of plasticizers include glycerin ester compounds, citric ester compounds, sebacic ester compounds, adipic ester compounds, polyether ester compounds, benzoic ester compounds, phthalic ester compounds, isosorbide ester compounds, polycaprolactone compounds, and dibasic ester compounds. Among these, glycerin ester compounds, citric ester compounds, sebacic ester compounds, and dibasic ester compounds are preferred because they are particularly superior in the plasticizing effect on the polyhydroxyalkanoate resin component. Examples of the glycerin ester compounds include glycerin diacetomonolaurate. Examples of the citric ester compounds include tributyl acetylcitrate. Examples of the sebacic ester compounds include dibutyl sebacate. Examples of the dibasic ester compounds include benzyl methyl diethylene glycol adipate. The amount of the plasticizer used is not limited to a particular range but is preferably from 1 to 20 parts by weight, more preferably from 2 to 15 parts by weight, and even more preferably from 3 to 10 parts by weight per 100 parts by weight of the PHA resin component. One plasticizer may be used alone, or two or more plasticizers may be mixed. The mix proportions of the plasticizers can be adjusted as appropriate depending on the intended purpose.

The thickness of the resin layer containing the PHA resin component (this layer is hereinafter also referred to as the “PHA resin layer”) is not limited to a particular range but is preferably from 20 to 100 μm, more preferably from 25 to 80 μm, and even more preferably from 30 to 60 μm. When the thickness is in the above range, the resin layer can be prevented from having defects such as pinholes, can impart sufficient toughness for practical use to the laminate while ensuring enough flexibility, and can effectively exhibit properties such as water resistance and oil resistance.

The thickness of the PHA resin layer and the thickness of the paper substrate are preferably set such that the average thickness ratio of the resin layer to the paper substrate layer (resin layer/paper substrate layer) is from 0.05 to 0.25. When the average thickness ratio is in this range, the resin layer can effectively exhibit properties such as water resistance and oil resistance. Additionally, curling of the resulting laminate can be reduced, and the laminate can be transferred in a desired way in a packaging material-producing machine such as a bag-making machine.

### Adhesive Layer

The adhesive layer of the present embodiment is a layer located between the paper substrate layer and the resin layer in the laminate to bond the paper substrate layer and the resin layer to each other. In production of the laminate, the adhesive layer is formed on the resin layer.

Examples of the adhesive used to form the adhesive layer include, but are not limited to: polyvinyl acetate adhesives; polyacrylic ester adhesives; cyanoacrylate adhesives; ethylene copolymer adhesives; cellulose adhesives; polyester adhesives; polyamide adhesives; polyimide adhesives; amino resin adhesives such as urea resins and melamine resins; phenolic resin adhesives; epoxy adhesives; polyurethane adhesives such as a cured product of a polyol and an isocyanate compound; rubber adhesives such as chloroprene rubber, nitrile rubber, and styrene-butadiene rubber; and silicone adhesives. One of these adhesives may be used alone, or two or more thereof may be mixed. The mix proportions of the adhesives can be adjusted as appropriate depending on the intended purpose. Among the mentioned adhesives, polyurethane adhesives are preferred due to their high adhesion and high heat resistance.

The amount of the adhesive to be applied is not limited to a particular range and may be chosen as appropriate in view of factors such as the performance required of the laminate and the productivity. To be specific, the amount of the applied adhesive is preferably such that the dry weight of the adhesive layer is from 3 to 10 g/m². When the dry weight is 3 g/m² or more, the adhesive layer tends to conform to the irregularities of the surface of the paper substrate layer and exhibit enhanced adhesion. Controlling the dry weight to 10 g/m² or less is economical and can reduce the risk that the solvent of the adhesive remains in the paper substrate.

### Gas Barrier Layer

The laminate according to the present embodiment may include a gas barrier layer formed as necessary. The gas barrier layer may be formed on the surface of the PHA resin layer and may be formed either on the side of the PHA resin layer that contacts the adhesive layer or on the other side opposite from the adhesive layer. The gas barrier layer may be located between a plurality of the PHA resin layers.

The gas barrier layer is not limited to a particular type and may be any layer that blocks gas permeation and has lower gas permeability than the paper substrate layer and the resin layer. A conventionally known gas barrier layer can be used, and specific examples of the gas barrier layer include a metal foil such as an aluminum foil, a vapor-deposited layer, a resin film, and a coating layer made of an inorganic substance. The gas barrier layer used may consist of only one type of layer or may include two or more types of layers placed one on another.

The vapor-deposited layer contains an inorganic material and may be made only of the inorganic material. Examples of the inorganic material include metals and inorganic oxides. Specific examples include, but are not limited to, aluminum, aluminum oxide, silicon oxides (such as silicon monoxide, silicon dioxide, and silicon oxynitride), cerium oxide, calcium oxide, and diamond-like carbon. One of these materials may be used alone, or two or more thereof may be used in combination. In terms of the adhesion after vapor deposition, the vapor-deposited layer is preferably a vapor-deposited metal layer, a vapor-deposited metal oxide layer, or a vapor-deposited silicon oxide layer and particularly preferably a vapor-deposited aluminum layer or a vapor-deposited silicon oxide layer.

The thickness of the vapor-deposited layer is not limited to a particular range. In terms of factors such as productivity, handleability, and appearance, the thickness of the vapor-deposited layer is preferably from 5 to 100 nm and more preferably from 5 to 60 nm. When the thickness of the vapor-deposited layer is 5 nm or more, the vapor-deposited layer is less likely to have defects and has good barrier performance. When the thickness of the vapor-deposited layer is 100 nm or less, the cost for vapor deposition is low, and the vapor-deposited layer has a good appearance without conspicuous coloring.

Examples of the resin film forming the gas barrier layer include a polyvinyl alcohol film, a film of a polyvinyl alcohol derivative such as carboxy-modified polyvinyl alcohol, sulfonated polyvinyl alcohol, or ethylene-modified polyvinyl alcohol, an ethylene-vinyl alcohol copolymer film, a polyglycolic acid film, and a film of a polyolefin such as polyethylene or polypropylene.

Examples of the inorganic substance forming the gas barrier layer include talc, clay, kaolin, montmorillonite, and vermiculite plate-like crystals.

The gas barrier layer preferably includes at least one selected from the group consisting of a metal foil, a vapor-deposited metal layer, a vapor-deposited metal oxide layer, a vapor-deposited silicon oxide layer, a polyvinyl alcohol film, and an ethylene-vinyl alcohol copolymer film and more preferably includes at least one selected from the group consisting of a metal foil, a vapor-deposited metal layer, a vapor-deposited metal oxide layer, and a vapor-deposited silicon oxide layer. The thickness of the gas barrier layer can be chosen as appropriate in view of the desired level of gas barrier performance.

### Printed Layer and Protective Layer

The laminate according to the present embodiment may further include a printed layer to enhance the aesthetic appeal of the laminate. When the laminate includes the printed layer, printing may be performed on the paper substrate layer or the resin layer. When the laminate includes the gas barrier layer, the resin layer, the gas barrier layer, and the printed layer may be formed in this order. The printed layer may be a single layer or may consist of a plurality of layers including a decorative layer and a protective layer.

The printed layer is not limited to particular details and can be formed by a known printing method using a known printing ink. The printing ink used is an ink prepared by mixing a binder resin with a pigment, a dye, a stabilizer, a plasticizer, a catalyst, a curing agent etc. as appropriate. Examples of the binder resin include, but are not limited to, acrylic resins, styrene resins, polyester resins, urethane resins, chlorinated polyolefin resins, vinyl chloride-vinyl acetate copolymer resins, polyvinyl butyral resins, alkyd resins, petroleum resins, ketone resins, epoxy resins, melamine resins, fluorine resins, silicone resins, and rubber resins. One of these resins may be used alone or two or more thereof may be used as a mixture. Examples of the printing method include gravure printing, offset printing, gravure offset printing, flexographic printing, and inkjet printing. The printing ink may be a solvent-based ink or an aqueous ink.

The thickness of the printed layer is not limited to a particular range. In general, the thickness of the printed layer is preferably from about 1 to about 10 μm.

Hereinafter, the steps of the production method according to the present embodiment will be described.

The production method according to the present embodiment includes molding a film containing a PHA resin component, applying an adhesive to the film, and attaching a paper substrate to the film, and these steps are performed in the order mentioned. A laminate can indeed be produced by applying an adhesive to a paper substrate and then attaching a film to the paper substrate; however, with this method, the solvent contained in the adhesive could seep and remain in the paper, and the resulting laminate could emit an odor derived from the solvent.

In the case of extrusion lamination in which a laminate is produced by extruding a molten resin onto a paper substrate, when the paper substrate has a high air resistance, the molten resin cannot easily infiltrate the paper substrate, and this tends to result in insufficient adhesion.

To be specific, the production method according to the present embodiment is preferably carried out as follows: First, a PHA resin film wound in a roll is prepared; the PHA resin film is continuously rolled out and transferred by means of a common film transfer device; application and drying of an adhesive on the PHA resin film are performed continuously; a separately prepared paper substrate wound in a roll is rolled out and fed from another transfer device and continuously attached to the film.

### Step of Molding Film Containing PHA Resin Component

The PHA resin component-containing film (hereinafter also referred to as the “PHA resin film”) of the present embodiment can be produced by any of various known molding methods such as T-die extrusion molding, blown film molding, and calender molding. The specific conditions may be set as appropriate. For example, in blown film molding or T-die extrusion molding, the set temperature of the cylinder is preferably from 100 to 160° C., and the set temperatures of the adapter and the die are preferably from 160 to 170° C.

The surface temperature of the cooling roll used in T-die extrusion molding is not limited to a particular range and may be any temperature that enables cooling and pressure-bonding of the PHA resin layer. The surface temperature of the cooling roll can be chosen as appropriate. The surface temperature of the cooling roll is preferably from 35 to 70° C. and more preferably from 40 to 60° C. When the surface temperature of the cooling roll is in the above range, crystallization of the PHA resin component is accelerated so that sticking of the PHA resin film to the cooling roll can be reduced to obtain a resin film with a good appearance. A metal roll is suitable for use as the cooling roll. To avoid blocking between the cooling roll and the PHA resin film, the surface of the cooling roll may be subjected to blasting treatment or release coating treatment. Examples of the release coating treatment include coating with a fluorine coat, coating with a ceramic coat, and coating with Tosical (registered trademark of Tosico Corporation) coat.

### Step of Forming Adhesive Layer

The adhesive layer can be formed by applying the adhesive described above to the surface of the PHA resin film and drying the applied adhesive through a process such as heating for removal of a solvent or the like which may be contained in the adhesive.

The application of the adhesive to the PHA resin film is not limited to using a particular method and can be accomplished by any known method. Specifically, a spray method, a spreading method, a slit coater method, an air knife coater method, a roll coater method, a bar coater method, a comma coater method, a blade coater method, a screen printing method, or a gravure printing method can be used.

Before the application of the adhesive, the PHA resin film may be subjected to a surface treatment such as corona treatment, plasma treatment, ozone treatment, or anchor coat treatment. Among these treatments, corona treatment or plasma treatment is preferred due to its simplicity.

The drying subsequent to the application of the adhesive to the PHA resin film can be performed by passing the PHA resin film with the applied adhesive through a hot air drying oven controlled to a given temperature. The drying temperature is not limited to a particular range, but the set temperature of the drying oven and the transfer speed of the film are preferably adjusted such that the temperature reached by the adhesive layer is equal to or higher than the boiling point of the solvent used in the adhesive. Specifically, the temperature reached by the adhesive layer is preferably 80° C. or higher in view of the boiling point of ethyl acetate, methyl ethyl ketone, 2-propanol, ethanol, or the like which is widely used as a solvent for adhesives. The temperature reached by the adhesive layer can be measured by means of a non-contact infrared thermometer for the surface of the adhesive layer that has just come out of the drying oven.

Since the PHA resin film of the present embodiment has a melting peak at 130° C. or higher, the film can avoid being extended, contracted, or corrugated when exposed to the drying conditions described above.

### Step of Attaching Paper Substrate

The attachment of the paper substrate is preferably performed by pressing the PHA resin film with the formed adhesive layer and the paper substrate between two rolls and continuously pressure-bonding the PHA resin film and the paper substrate to each other. The material of each of the rolls used is not limited to a particular type. Preferably, the PHA resin film and the paper substrate are pressed between a metal roll and a rubber roll to ensure that the adhesive layer conforms to the irregularities of the surface of the paper substrate and exhibits good adhesion to the paper substrate. In particular, the conformity of the adhesive layer to the surface of the paper substrate can be enhanced by placing the metal roll in contact with the PHA resin film and controlling the temperature of the metal roll. The temperature control of the metal roll can be done by using any suitable known means such as water, steam, an oil, or dielectric heating. To avoid blocking between the metal roll and the PHA resin film, the surface of the metal roll may be subjected to blasting treatment or release coating treatment. Examples of the release coating treatment include coating with a fluorine coat, coating with a ceramic coat, and coating with Tosical (registered trademark of Tosico Corporation) coat.

The previously-described surface treatment such as corona treatment, plasma treatment, flame treatment, or ozone treatment of the side of the paper substrate that is to be brought into contact with the adhesive layer is preferably performed in a production line immediately before the pressing between rolls in order to avoid a decline in the effect of the treatment.

### Molded Article

The laminate that can be produced according to the present embodiment can be shaped into a molded article (hereinafter also referred to as the “present molded article”) having a given shape. The molded article includes the laminate and has a desired size and shape. Being made with the laminate including the resin layer containing a PHA, the present molded article is advantageous for various uses.

The present molded article is not limited to a particular product and may be any product including the present laminate. Examples of the present molded article include paper, a film, a sheet, a tube, a plate, a rod, a container (e.g., a bottle), a bag, and a part. In terms of addressing marine pollution, the present molded article is preferably a packaging bag, a lidding material, or a container such as a cup or tray.

In one embodiment of the present disclosure, the present molded article may be the present laminate itself or may be one produced by secondary processing of the present laminate. The molded article may be produced by secondary processing in which the laminate is combined with another product by using the resin layer as a heat-scalable layer.

The present molded article including the present laminate subjected to secondary processing is suitable for use as any of various kinds of packaging bags such as shopping bags, side seal packs, three side seal packs, pillow packs, and standing pouches or for use as any of various kinds of packaging containers such as cups, trays, and cartons. That is, the present molded article is suitable for use in diverse fields such as food industry, cosmetic industry, electronic industry, medical industry, and pharmaceutical industry. Since the present laminate contains a resin having high adhesion to the substrate and having good heat resistance, the present molded article is particularly suitable for use as a container for a hot substance. Examples of such a container include: a liquid container such as, in particular, a cup for a food or beverage such as instant noodle, instant soup, or coffee; and a tray used for a prepared food, boxed lunch, or microwavable food. When the laminate includes the gas barrier layer between the paper substrate layer and the resin layer, the present molded article is suitable for use as a packaging material for holding a product such as a dried food (e.g., instant noodle, nut, or dried fruit), any kind of solid seasoning, a chocolate, or tea leaf whose flavor or taste needs to be kept intact.

The secondary processing can be performed using any method known in the art. For example, the secondary processing can be performed by means such as any kind of a bag-making machine or form-fill-seal machine. Alternatively, the secondary processing may be performed using a device such as a paper tray press molding machine, a paper cup molding machine, a punching machine, or a case former. In any of these processing machines, any known bonding technique can be used to obtain the molded article. An example of the bonding technique is ordinary heat sealing. Other examples include impulse sealing, ultrasonic sealing, high-frequency scaling, hot air sealing, and flame sealing. The heat sealing may be performed between the paper substrate layer and the resin layer or between different portions of the resin layer.

In the case where different portions of the resin layer of the laminate are heat-sealed together by means of a heat sealing tester equipped with a sealing bar and where the laminate is heated from both sides in the heat sealing, the heat sealing temperature is typically from 150 to 200° C., preferably from 160 to 190° C., and more preferably from 170 to 180° C. In the case where the resin layer and the paper substrate layer of the laminate are heat-sealed together by means of a heat sealing tester equipped with a sealing bar and where the laminate is heated from both sides in the heat sealing, the heat sealing temperature is typically from 160 to 220° C., preferably from 170 to 210° C., and more preferably from 180 to 200° C. When the heat sealing temperature is in the above range, melting and leakage of the resin in the vicinity of the sealed portion can be avoided to ensure a suitable thickness of the resin layer and suitable seal strength.

The heat sealing pressure at which the laminate is heat-sealed depends on the bonding technique used. In the case where heat sealing is performed to obtain the molded article by means of a heat sealing tester equipped with a sealing bar, the heat sealing pressure is typically 0.1 MPa or more and preferably 0.3 MPa or more. When the heat sealing pressure is equal to or higher than the above level, satisfactory bond strength can be achieved by the heat sealing.

The molded article according to the present embodiment may, for the purpose of physical property improvement, be combined with another molded article (such as a fiber, a yarn, a rope, a woven fabric, a knit, a non-woven fabric, paper, a film, a sheet, a tube, a plate, a rod, a container, a bag, a part, or a foam) made of a different material than the molded article according to the present embodiment. The material of the other molded article is also preferably biodegradable.

In the following items, preferred aspects of the present disclosure are listed. The present invention is not limited to the following items.

### Item 1

A method for producing a laminate including a paper substrate layer and a resin layer formed on at least one side of the paper substrate layer, the paper substrate layer having an air resistance of 90 sec or more, the resin layer containing a polyhydroxyalkanoate resin, the method including the sequential steps of:
(i) molding a film containing a polyhydroxyalkanoate resin component, wherein in differential scanning calorimetry of the polyhydroxyalkanoate resin component, a highest melting peak temperature is 130° C. or higher and a total crystalline melting enthalpy calculated from all melting peaks is in a range of 30 to 65 J/g;
(ii) applying an adhesive to one side of the film to form an adhesive layer; and
(iii) placing the paper substrate layer on a surface of the adhesive layer.

### Item 2

The method according to item 1, wherein
the polyhydroxyalkanoate resin component is a mixture of at least two polyhydroxyalkanoate resins differing in crystalline melting enthalpy.

### Item 3

The method according to item 1 or 2, wherein
the polyhydroxyalkanoate resin component contains poly (3-hydroxybutyrate-co-3-hydroxyhexanoate).

### Item 4

The method according to any one of items 1 to 3, wherein
the polyhydroxyalkanoate resin component is a mixture of poly (3-hydroxybutyrate-co-3-hydroxyhexanoate) (A) containing 1 to 6 mol % of 3-hydroxyhexanoate structural units and poly (3-hydroxybutyrate-co-3-hydroxyhexanoate) (B) containing 24 mol % or more of 3-hydroxyhexanoate structural units.

### Item 5

The method according to item 4, wherein
in 100 parts by weight of the mixture, a proportion of the poly (3-hydroxybutyrate-co-3-hydroxyhexanoate) (A) is from 50 to 80 parts by weight and a proportion of the poly (3-hydroxybutyrate-co-3-hydroxyhexanoate) (B) is from 20 to 50 parts by weight.

### Item 6

The method according to any one of items 1 to 5, wherein
the adhesive is a polyurethane adhesive.

### Item 7

The method according to any one of items 1 to 6, wherein
an average thickness ratio of the resin layer to the paper substrate layer (resin layer/paper substrate layer) is from 0.05 to 0.25.

### Item 8

A method for producing a molded article, including the steps of:
producing a laminate by the method according to any one of items 1 to 7; and
shaping the laminate.

### Item 9

### A laminate including a paper substrate layer, an adhesive layer, and a resin layer, wherein

the laminate meets the following requirements:
(A) the paper substrate layer has an air resistance of 90 sec or more;
(B) the resin layer contains a polyhydroxyalkanoate resin component, wherein in differential scanning calorimetry of the polyhydroxyalkanoate resin component, a highest melting peak temperature is 130° C. or higher and a total crystalline melting enthalpy calculated from all melting peaks is in a range of 30 to 65 J/g; and
(C) the paper substrate layer, the adhesive layer, and the resin layer are arranged in this order.

### Item 10

A molded article including the laminate according to item 9.

### Item 11

The molded article according to item 10, being a packaging bag, a lidding material, or a container.

### Item 12

The molded article according to item 11, for use in a food product.

### EXAMPLES

Hereinafter, the present invention will be specifically described based on examples. The technical scope of the present invention is not limited by the examples given below.

Raw materials used to form resin layers in Examples and Comparative Examples are listed below.

### Polyhydroxyalkanoate (PHA) Resins

P3HB3HH-1: P3HB3HH (average content ratio 3HB/3HH=94/6 (mol %/mol %), weight-average molecular weight=40×10⁴ g/mol): this resin was produced according to a method described in Example 1 of WO 2019/142845.
P3HB3HH-2: P3HB3HH (average content ratio 3HB/3HH=97/3 (mol %/mol %), weight-average molecular weight=60×10⁴ g/mol): this resin was produced according to Example 2 of WO 2019/142845.
P3HB3HH-3: P3HB3HH (average content ratio 3HB/3HH=72/28 (mol %/mol %), weight-average molecular weight=100×10⁴ g/mol): this resin was produced according to a method described in Example 9 of WO 2019/142845.
P3HB3HH-4: P3HB3HH (average content ratio 3HB/3HH=72/28 (mol %/mol %), weight-average molecular weight=60×10⁴ g/mol): this resin was produced according to a method described in Example 9 of WO 2019/142845.
P3HB3HH-5: P3HB3HH (average content ratio 3HB/3HH=83/17 (mol %/mol %), weight-average molecular weight=70×10⁴ g/mol): this resin was produced according to a method described in Example 7 of WO 2019/142845.

The average content ratio (3HB/comonomer) shown in Table 1 for the case where a mixture of two or more PHA resins was used as the PHA resin component is an average value calculated from the values of the average content ratio 3HB/comonomer in the PHA resins and the proportions by weight of the PHA resins.
Nucleating agent: Pentaerythritol (Neulizer P manufactured by Mitsubishi Chemical Corporation)
Lubricant: Behenamide (BNT-22H manufactured by Nippon Fine Chemical Co., Ltd.)
Adhesive: Urethane dry lamination adhesive (manufactured by Toyo-Morton, Ltd., base material: TM-569, curing agent: CAT-RT37, solvent: ethyl acetate)

### Production of PHA Resin Pellets

The PHA resin(s), pentaerythritol, and behenamide were dry-blended (the resin component in a non-molten state was mixed with the other components) in the proportions (parts by weight) shown in Table 1. The resulting mixture was melted, kneaded, and extruded as a strand by a twin-screw extruder. The strand was crystallized and solidified by passing it through a water bath heated to 40° C. and was then cut by a pelletizer. In this way, PHA resin pellets 1 to 6 were prepared.

### Measurement of Melting Peak Temperature and Crystalline Melting Enthalpy in Differential Scanning Calorimetry

The PHA resin pellets obtained as above were subjected to differential scanning calorimetry which used a differential scanning calorimeter (DSC 25 manufactured by TA Instruments) and in which about 2 mg of the PHA resin pellets were heated from −30 to 180° C. at a temperature increase rate of 10° C./min. In the DSC curve obtained by the differential scanning calorimetry, the highest of temperatures at which melting peaks were detected was determined. Additionally, in the DSC curve, baselines observed before the start of melting and after the end of melting were connected by a straight line, and a total quantity of heat calculated as the area of the melting zone surrounded by the straight line and the DSC curve was determined as the total crystalline melting enthalpy. The results are listed in Table 1. The DSC curve obtained for the PHA resin component of Example 1 is shown as a measurement example in FIG. 1.

TABLE 1

| | Proportions (parts by weight) | | | | | |
|---|---|---|---|---|---|---|
| | | | | | | Nucleating |
| | PHA resin | | | | | agent |
| | P3HB3HH-1 | P3HB3HH-2 | P3HB3HH-3 | P3HB3HH-4 | P3HB3HH-5 | Pentaerythritol |
| Resin pellets 1 | 55 | | 45 | | | 1 |
| Resin pellets 2 | | 65 | | 35 | | 1 |
| Resin pellets 3 | | 75 | | 25 | | 1 |
| Resin pellets 4 | 45 | | 55 | | | 1 |
| Resin pellets 5 | 100 | | | | | 1 |
| Resin pellets 6 | | | | | 100 | 1 |

| | Proportions (parts by weight) | Average content | Highest melting | Total crystalline |
|---|---|---|---|---|
| | Lubricant | ratio | peak temperature | melting enthalpy |
| | Behenamide | 3HB/Comonomer | ° C. | J/g |
| Resin pellets 1 | 0.5 | 84/16 | 143 | 34 |
| Resin pellets 2 | 0.5 | 88/12 | 153 | 58 |
| Resin pellets 3 | 0.5 | 91/9 | 151 | 64 |
| Resin pellets 4 | 0.5 | 82/18 | 143 | 28 |
| Resin pellets 5 | 0.5 | 94/6 | 142 | 68 |
| Resin pellets 6 | 0.5 | 83/17 | 100 | 31 |

### Production of Laminate

### Example 1

The PHA resin pellets 1 obtained as above were placed into a single-screw extruder equipped with a T-die having a lateral width of 500 mm and a lip opening width of 0.25 mm. The cylinder temperature was set in the range of 140 to 160° C. and the T-die temperature was set to 170° C. The PHA resin material was extruded from the extruder and received onto a cooling roll controlled to 40° C. The opposite edges of the resulting film were trimmed, and the film was wound in a roll. Thus, a PHA resin film with a width of 300 mm and a thickness of 35 to 45 μm was produced.

The PHA resin film obtained as above was fed from a feeder and subjected to corona treatment. The urethane dry lamination adhesive was applied to the corona-treated side of the film, and then the film with the applied adhesive was passed through a drying oven to dry the adhesive and thus form an adhesive layer having a weight per square meter of 5 g/m². In the drying process, the drying oven temperature and the film transfer speed were adjusted such that the surface temperature of the adhesive layer (as measured by a non-contact infrared thermometer) was 90° C. at the outlet of the drying oven.

Cup paper with a width of 350 mm (manufactured by Oji F-Tex Co., Ltd.: weight per square meter=250 g/m², thickness=290 μm, air resistance=92 sec) was fed from another feeder and attached to the adhesive layer formed as above. In this way, a laminate including a resin layer, an adhesive layer, and a paper substrate layer was produced.

### Methods for Evaluation of Laminate

The produced laminate was evaluated for the appearance of the resin layer, the adhesion between the paper substrate layer and the PHA resin layer, the odor of the laminate, and the toughness of the resin layer. The results are listed in Table 2.

### Appearance of Resin Layer

The surface of the resin layer of the obtained laminate was visually inspected, and the appearance of the resin layer was rated according to the following criteria.

### Rating Criteria

Excellent: There is no unbonded portion such as a gap between the resin layer and the paper substrate layer, and the resin layer is smooth and has a good appearance.
Good: The edges of the width of the resin layer have wrinkles, but there is no unbonded portion such as a gap between the central region of the width of the resin layer and the paper substrate layer. The resin layer is smooth and has a good appearance.
Poor: The central region of the width of the resin layer has wrinkles and there is an unbonded portion between the resin layer and the paper substrate layer.

### Adhesion Between Paper Substrate Layer and PHA Resin Layer

The resin layer was cut with a cutter knife to make a crosscut pattern with a length of 30 mm and was peeled by hand. The peeled surface was visually inspected, and the adhesion between the paper substrate layer and the resin layer was rated according to the following criteria.

### Rating Criteria

Good: The paper undergoes material failure.
Poor: The paper does not undergo material failure, and the resin layer is easily peeled without resistance.

### Odor of Laminate

Each of the laminates obtained in Examples or Comparative Examples was cut to give a 100-mm-square flat sheet, which was enclosed in a polyethylene bag. After 1 hour, odor sensory evaluation was conducted according to the following rating criteria.

### Rating Criteria

Good: There is no irritating odor of the ethyl acetate solvent derived from the adhesive.
Poor: There is an irritating odor of the ethyl acetate solvent derived from the adhesive.

### Method for Evaluating Toughness of Resin Layer

Each of the laminates obtained in Examples or Comparative Examples was cut to give a strip having a width of 15 mm and a length of 30 mm. The strip was bent at 180° by fingers, with the resin layer facing outward. An ageless seal check solution (manufactured by (Mitsubishi Gas Chemical Company, Inc.) was applied to the bent portion, and coloring of the resin layer was visually inspected. The toughness of the resin layer was rated according to the following rating criteria.

### Rating Criteria

Good: Coloring along the fold line of the bent portion is not found.
Poor: Coloring along the fold line of the bent portion is found.

### Examples 2 and 3 and Comparative Examples 1 to 3

Film fabrication and laminate production were performed in the same manner as in Example 1, except that the PHA resin pellets listed in Table 2 were used. Each of the produced laminates was evaluated in the same manner as the laminate of Example 1. The results are listed in Table 2.

### Comparative Example 4

The PHA resin pellets 2 were placed into a single-screw extruder equipped with a T-die having a lateral width of 500 mm and a lip opening width of 0.25 mm. The cylinder temperature was set in the range of 140 to 160° C. and the T-die temperature was set to 170° C. The PHA resin material was extruded from the extruder onto one side of separately fed cup paper having a width of 350 mm (manufactured by Oji F-Tex Co., Ltd.: weight per square meter=250 g/m², thickness=290 μm, air resistance=92 sec). The extruded resin material and the cup paper were pressed together between a metal roll and a rubber roll whose temperatures were controlled to 40° C., and the resulting layered sheet was trimmed and wound in a roll. In this way, a laminate made up of a resin layer and a paper substrate layer and having a width of 300 mm and a thickness of 35 to 45 μm was produced.

The produced laminate was evaluated in the same manner as the laminate of Example 1. The results are listed in Table 2.

### Comparative Example 5

Laminate production was performed in the same manner as in Example 1, except that the adhesive was applied to and dried on cup paper rather than a PHA resin film and then a PHA film was attached to the surface of the adhesive layer formed on the cup paper. The produced laminate was evaluated in the same manner as the laminate of Example 1. The results are listed in Table 2.

TABLE 2

| | | | Adhesion | | |
|---|---|---|---|---|---|
| | | | between | | |
| | | | paper | | |
| | | Appearance | substrate | | Toughness |
| | Resin | of resin | layer and | Odor of | of resin |
| | pellets | layer | resin layer | laminate | layer |
| Ex. 1 | 1 | Good | Good | Good | Good |
| Ex. 2 | 2 | Excellent | Good | Good | Good |
| Ex. 3 | 3 | Excellent | Good | Good | Good |
| Comp. 1 | 4 | Poor | Good | Good | Good |
| Comp. 2 | 5 | Excellent | Good | Good | Poor |
| Comp. 3 | 6 | Poor | Good | Good | Poor |
| Comp. 4 | 2 | Excellent | Poor | Without | Good |
| | | | | adhesive | |
| Comp. 5 | 2 | Excellent | Good | Poor | Good |

### Results

Table 2 reveals that in the laminates obtained in Examples, there was no unbonded portion between the paper substrate layer and the resin layer, and the resin layer had a good appearance. It is also seen that the interlayer adhesion and the toughness of the resin layer were good.

In contrast, in the laminates of Comparative Examples 1 to 3, the resin layer failed to have both a good appearance and good toughness because of the use of a PHA resin component that did not have a given melting behavior.

In Comparative Example 4, where the laminate was produced by extrusion lamination, the resin had difficulty infiltrating the paper substrate having a high air resistance, and the interlayer adhesion was insufficient.

In Comparative Example 5, where an adhesive was applied to and dried on a paper substrate and then a resin layer was placed on the adhesive layer, the solvent of the adhesive seeped into the paper substrate and was not fully removed by drying, causing an odor remaining in the laminate.

1. A method for producing a laminate comprising a paper substrate layer and a resin layer formed on at least one side of the paper substrate layer, wherein the paper substrate layer has an air resistance of at least 90 sec, and the resin layer comprises a polyhydroxyalkanoate resin,
the method comprising sequentially:
(i) molding a film comprising a polyhydroxyalkanoate resin component, wherein in differential scanning calorimetry of the polyhydroxyalkanoate resin component, a highest melting peak temperature is at least 130° C. and a total crystalline melting enthalpy calculated from all melting peaks is from 30 to 65 J/g;
(ii) applying an adhesive to one side of the film to form an adhesive layer; and
(iii) placing the paper substrate layer on a surface of the adhesive layer.

2. The method according to claim 1, wherein the polyhydroxyalkanoate resin component is a mixture of at least two polyhydroxyalkanoate resins different in crystalline melting enthalpy.

3. The method according to claim 1, where the polyhydroxyalkanoate resin component comprises poly (3-hydroxybutyrate-co-3-hydroxyhexanoate).

4. The method according to claim 1, wherein the polyhydroxyalkanoate resin component is a mixture of poly (3-hydroxybutyrate-co-3-hydroxyhexanoate) (A) comprising from 1 to 6 mol % of 3-hydroxyhexanoate structural units and poly (3-hydroxybutyrate-co-3-hydroxyhexanoate) (B) containing 24 mol % or more of 3-hydroxyhexanoate structural units.

5. The method according to claim 4, wherein in 100 parts by weight of the mixture, a proportion of the poly (3-hydroxybutyrate-co-3-hydroxyhexanoate) (A) is from 50 to 80 parts by weight and a proportion of the poly (3-hydroxybutyrate-co-3-hydroxyhexanoate) (B) is from 20 to 50 parts by weight.

6. The method according to claim 1, wherein the adhesive is a polyurethane adhesive.

7. The method according to claim 1, wherein an average thickness ratio of the resin layer to the paper substrate layer, resin layer/paper substrate layer, is from 0.05 to 0.25.

8. A method for producing a molded article, comprising:
producing a laminate by the method according to claim 1; and
shaping the laminate.

9. A laminate comprising a paper substrate layer, an adhesive layer, and a resin layer, wherein
the laminate meets the following requirements:
(A) the paper substrate layer has an air resistance of at least 90 sec;
(B) the resin layer comprises a polyhydroxyalkanoate resin component, wherein in differential scanning calorimetry of the polyhydroxyalkanoate resin component, a highest melting peak temperature is at least 130° C. and a total crystalline melting enthalpy calculated from all melting peaks is from 30 to 65 J/g; and
(C) the paper substrate layer, the adhesive layer, and the resin layer are arranged in this order.

10. A molded article comprising the laminate of claim 9.

11. The molded article according to claim 10, being a packaging bag, a lidding material, or a container.

12. The molded article according to claim 11, for use in a food product.
